(19) United States
(12) Patent Application Publication
(10) Pub. No.: US 2006/0246339 A1
(43) Pub. Date: Nov. 2, 2006

(54) Fuel cell unit and electronic apparatus

(76) Inventors: Yasuaki Norimatsu, Hitachiota (JP); Hayami Toba, Hitachinaka (JP); Akihiro Kanouda, Hitachinaka (JP); Mutsumi Kikuchi, Hitachi (JP)

Correspondence Address: ANTONELLI, TERRY, STOUT & KRAUS, LLP, 1300 NORTH SEVENTEENTH STREET, SUITE 1800, ARLINGTON, VA, 22209-3873, US

(21) Appl. No.: 11/354,909

(22) Filed: Feb. 16, 2006

(30) Foreign Application Priority Data
Apr. 28, 2005 (JP) 2005-132084

(51) Int. Cl. H01M 2/08; H01M 8/10; H01M 8/02; H01M 8/04

(52) U.S. Cl. 429/35; 429/30; 429/32; 429/38; 429/26

(57) ABSTRACT

A fuel cell unit comprises a fuel cell body, a case and a seal member. The fuel cell body has a membrane electrode assembly for generating power, which comprises an anode being supplied with fluid fuel, a cathode being exposed to atmosphere to be supplied with an oxydant, a membrane sandwiched between the anode and cathode, and a fuel tank connected to a fuel cartridge, from which the liquid fuel is supplied to the anode. The case has an internal space for accommodating an electronic part, the case enclosing and holding the fuel cell body and having an opening in the area of the cathode of the membrane electrode assembly and opened to the outside. The seal member for providing a seal is disposed between the edges surrounding the opening in the case and the fuel cell body to shield the internal space from the opening.

### CLAIM OF PRIORITY

This application claims priority from Japanese application Serial No. 2005-132084, filed on Apr. 28, 2005, the content of which is hereby incorporated by reference into this application.

### BACKGROUND OF THE INVENTION

The present invention relates to a fuel cell unit that is supplied with liquid fuel from, for example, a direct methanol fuel cell (Hereinafter referred to as DMFC.) and generates power, as well as an electronic apparatus in which the fuel cell unit is mounted.

### DESCRIPTION OF PRIOR ART

Recent progress in electronic technology is rapidly making the widespread use of mobile electronic apparatus such as mobile telephones, notebook computers, audio-visual apparatus, and mobile terminals. These mobile electronic apparatuses are usually systems driven by secondary cells. Owing to the advent of new types of secondary cells as well as reduction in size and weight and increase in energy density, secondary cells have been developed from seal lead batteries to Li-ion batteries through Ni—Cd batteries and Ni-hydrogen batteries. For all of these secondary cells, active cell materials and high-capacity cell structures have been developed to increase the energy density, and efforts have been made to implement power supplies that can be used for a long period of time.

Although efforts are made so that each function of a mobile electronic apparatus consumes further less power, new functions need to be added to continue to meet increased user needs, so the total power consumption of a mobile electronic apparatus is predicted to increase. This will require high-density power supplies, that is, power supplies that can be used continuously for a long time of period.

Recently, fuel cells have attracted much attention as power supplies that provide a long continuous usage time. A fuel cell generates power by having fuel supplied to an anode (fuel pole) and oxygen to a cathode (air pole). When power is generated, the fuel cell yields products such as water (water vapor), carbon dioxides and ejects them.

Further specifically, a polymer electrolyte fuel cell (PEFC) and the like that uses hydrogen as fuel yields water as a product and ejects it, and direct methanol fuel cell (DMFC) and the like yields water and carbon dioxide as products and ejects them.

To supply fuel (methanol or hydrogen) to fuel cells and eject products (water and carbon dioxide) resulting from power generation, proposed active (forcible suction type) fuel cells use a pump, fan, blower, or other auxiliary unit and proposed passive (open type) fuel cells utilize natural diffusion of the methanol aqueous solution or air and so on without using an auxiliary unit. With both the active and passive fuel cells, the products such as water are finally ejected into the air.

To prevent the ejected water etc. from deteriorating electronic parts on boards and the like, a technology for keeping the water (including water vapor) out of the chamber in which electronic parts are accommodated is proposed (see Patent Document 1).

[Patent Document 1] Japanese unexamined patent application No 2004-71259 (paragraphs 0010 to 0023 and FIG. 1)

### SUMMARY OF THE INVENTION

In Patent Document 1, however, any technology for preventing entrance of water and the like is not disposed for passive fuel cells.

The present invention addresses this problem with the object of providing a fuel cell unit that has an internal space in which electronic parts can be preferably accommodated, as well as an electronic apparatus in which the fuel cell unit is mounted.

As a means to solve the problem described above, the present invention has a fuel cell unit that comprises a fuel cell body, case, and seal member. The full cell body has a membrane electrode assembly that generates power by having liquid fuel supplied to its anode and oxygen to its cathode and yields water vapor at the cathode due to the power generation, and includes a fuel tank connected to a fuel cartridge, from which liquid fuel is supplied to the anode. The case has an internal space for accommodating electronic parts, which encloses and holds the fuel cell body and has an opening formed by the cathode of the membrane electrode assembly and opened to the outside. The seal member provides a seal between the edges surrounding the opening in the case and the fuel cell body to shield the internal space from the opening.

This type of fuel cell unit enables liquid fuel to be supplied from the fuel cartridge to the anode and oxygen to be supplied to the cathode through the opening opened to the outside, causing the membrane electrode assembly to generate power. Due to the power generation, the cathode produces water (water vapor) and then the produced water is ejected through the opening to the outside. Since the opening is shielded by the seal member from the internal space, the water (including the water vapor) is kept out of the internal space of the case.

Accordingly, electronic parts can be preferably accommodated in the internal space of the case without having to consider the effect of the water.

Furthermore, the fuel cell body is preferably protected by the case that encloses and holds it.

The present invention provides a fuel cell unit that has an internal space in which electronic parts can be preferably accommodated and an electronic apparatus in which the fuel cell unit is mounted.

### BRIEF DESCRIPTION OF THE DRAWINGS

FIG. 1 is an overall perspective view of the notebook computer according to a first embodiment.

FIG. 2 is a schematic diagram showing the structure of the notebook computer according to the first embodiment.

FIG. 3 is an overall perspective view of the DMFC unit according to the first embodiment.

FIG. 4 is a cross-sectional view showing section X-X of the DMFC unit, shown in FIG. 3, according to the first embodiment.

FIG. 5 is an exploded perspective view of the DMFC unit according to the first embodiment.

FIG. 6 is a cross-sectional view of the DMFC unit according to the second embodiment.

FIG. 7 is a cross-sectional view of the DMFC unit according to the third embodiment.

FIG. 8 is a cross-sectional view of a variation of the DMFC unit according to the third embodiment.

FIG. 9 is an overall perspective view of a variation of the notebook computer and DMFC unit according to the first embodiment.

FIG. 10 is a perspective view of a portable phone of a fourth embodiment.

FIG. 12 is a perspective view of a portable phone of another embodiment.

FIG. 13 is a sectional view of the portable phone shown in FIG. 10.

FIG. 13 is a sectional view of the portable phone shown in FIG. 11.

### DETAILED DESCRIPTION OF PREFERRED EMBODIMENTS

Embodiments of the present invention will be described below with reference to the attached drawings.

### (1) First Embodiment

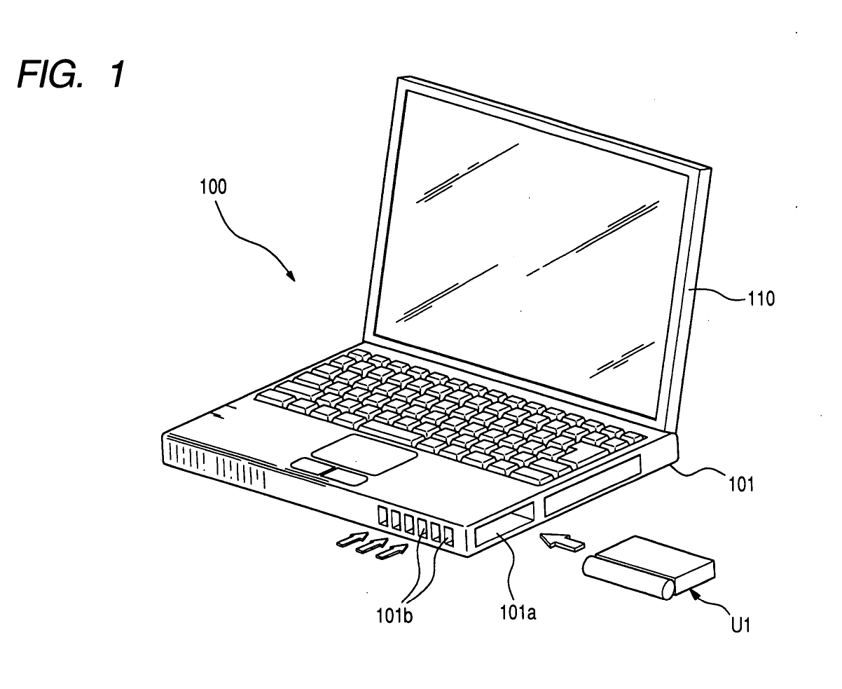

A direct methanol fuel cell (DMFC ) unit and a notebook computer (electronic apparatus) in which the DMFC unit is mounted, according to a first embodiment, will be described with reference to FIGS. 1 to 5. FIG. 1 is an overall perspective view of the notebook computer according to the first embodiment.

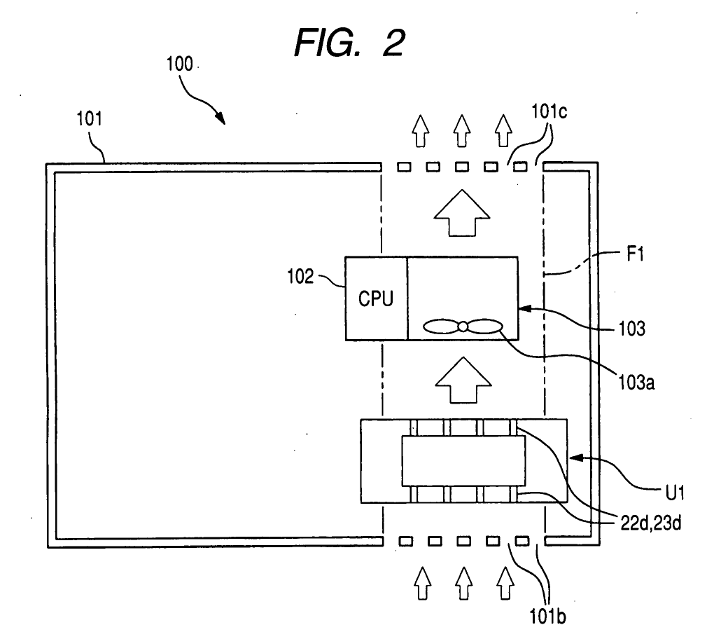

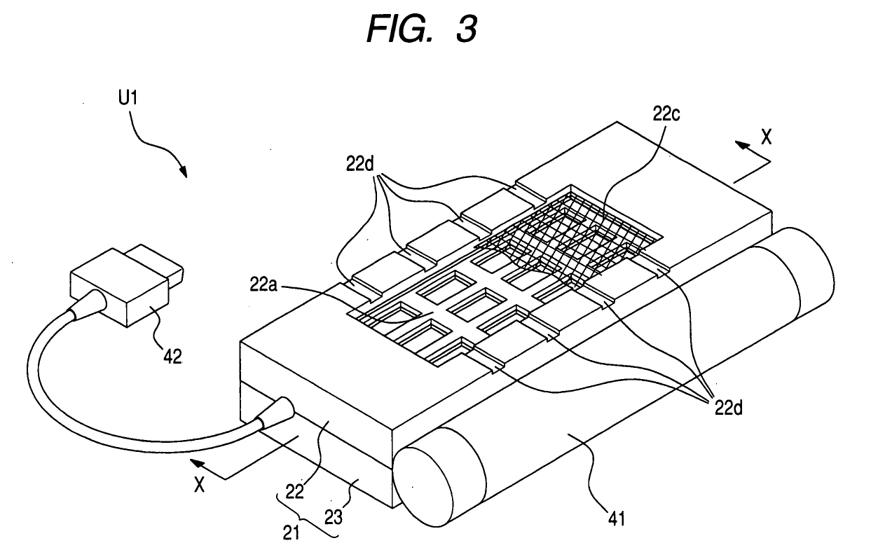

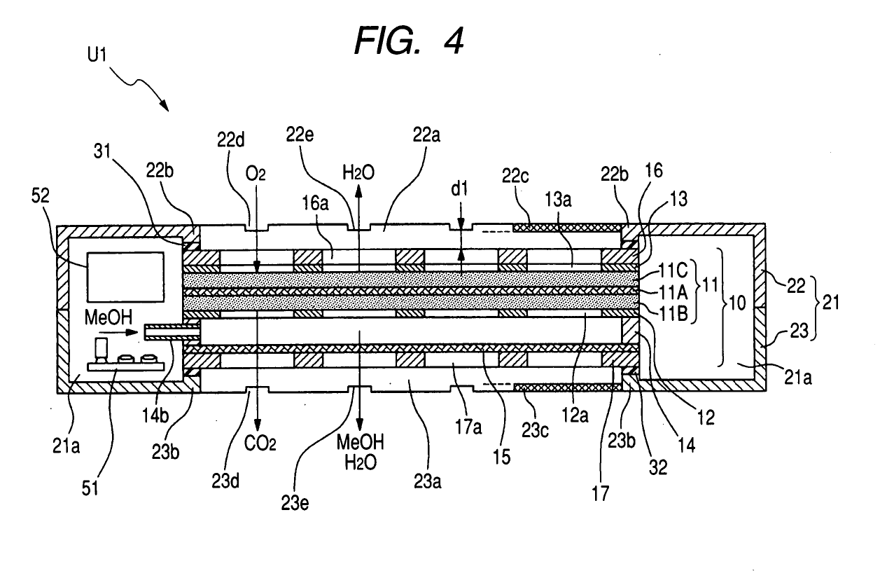

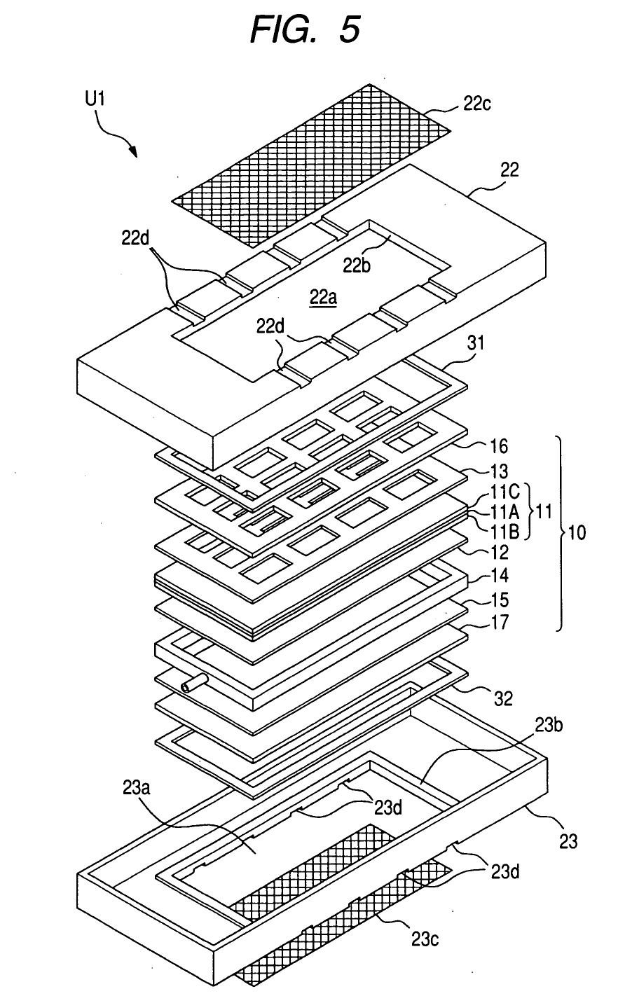

FIG. 2 is a schematic diagram showing the structure of the notebook computer according to the first embodiment. FIG. 3 is an overall perspective view of the DMFC unit according to the first embodiment. FIG. 4 is a cross-sectional view showing section X-X of the DMFC unit, shown in FIG. 3, according to the first embodiment. FIG. 5 is an exploded perspective view of the DMFC unit according to the first embodiment.

<<Notebook Computer>>

As shown in FIG. 1, the notebook computer 100 (electronic apparatus) according to the first embodiment mainly has a main body 101, a liquid crystal panel 110, and a DMFC unit U1 used as a power supply. The DMFC unit U1 is mounted in the notebook computer 100 by being accommodated in a slot 110a of the main body 101.

In addition to the components in FIG. 1, the notebook computer 100 mainly has a CPU 102, and a heat sink 103 for cooling the CPU 102, as shown in FIG. 2. When the notebook computer 100 is activated, a fan 103a of the heat sink 103 rotates, forming a flow path F1 through which air flows from inlet ports 101b on the main body 101 to outlet ports 101c.

The DMFC unit U1 is disposed above the flow path F1 for a flow of air. More specifically, grooves 22d and 23d (see FIGS. 3 and 4), described below, are formed above the flow path F1; when the fan 103a rotates, a flow of air from the inlet ports 101b toward the output ports 101c passes through the grooves 22d and 23d.

<<Structure of the DMFC Unit>>

Next, the DMFC unit U1 will be described mainly with reference to FIGS. 3 to 5.

As shown in FIGS. 3 to 5, the DMFC unit U1 mainly has a DMFC body 10 (fuel cell body), a case 21 that encloses and holds the DMFC body 10, a seal member 31, a fuel cartridge 41, a control board 51, and a capacitor 52. The DMFC unit U1 is a passive (open) fuel cell unit, which utilizes natural diffusion of methanol aqueous solution or air and the like without using a pump, fan, blower, or other auxiliary unit.

<DMFC Body>

The DMFC body 10 mainly has a membrane electrode assembly (MEA) 11, current collectors 12 and 13, a fuel tank 14, a carbon dioxide separating membrane 15, and interposing plates 16 and 17 (pressing plates). The DMFC body 10 is a lamination of the interposing plate 16, current collector 13, MEA 11, current collector 12, fuel tank 14, carbon dioxide separating membrane 15, and interposing plate 17, which are superposed in that order.

[MEA]

The MEA 11 mainly has an electrolyte membrane 11A such as a perfluorosulfonic acid-based monovalent cation-exchange membrane, as well as an anode 11B (fuel pole) and a cathode 11C (air pole) that interpose the electrolyte membrane 11A. The anode 11B and cathode 11C are formed by, for example, carbon paper in which platinum or another catalyst is supported.

[Current Collectors]

The current collector 12 (anode current collector) and current collector 13 (cathode current collector) are used to efficiently retrieve power according to the potential difference generated at the MEA 11. They are made of a material having conductivity and corrosion resistance such as, for example, titanium or another metal. The current collector 12 is disposed next to the anode 11B, and the current collector 13 is disposed next to the cathode 11C, the current collector 12 and current collector 13 interpose the MEA 11 between them.

A plurality of flow openings 12a is formed in the current collector 12. Methanol aqueous solution to be supplied to the anode 11B and carbon dioxide (gas) produced at the anode 11B due to power generation pass through the flow openings 12a. A plurality of flow openings 13a is formed in the current collector 13. Air including oxygen to be supplied to the cathode 11C and water vapor (water) produced at the cathode 11C due to power generation pass through the flow openings 13a.

The current collector 12 and current collector 13 are electrically connected to a connector 42 attached to the notebook computer 100 through wires (not shown), as shown in FIG. 3.

[Fuel Tank]

The fuel tank 14 is a frame-shaped secondary tank having a tank chamber 14a; methanol aqueous solution (fluid fuel) supplied from the fuel cartridge 41 (primary tank) is temporarily stored in the tank chamber 14a, and the methanol aqueous solution is supplied to the entire surface of the anode 11B.

More specifically, the fuel tank 14 is connected to the fuel cartridge 41 outside the case 21 through a fuel pipe 14b and tube (not shown). Methanol aqueous solution is thereby supplied from the fuel cartridge 41 to the tank chamber 14a. The anode 11B is overlaid on the fuel tank 14 through the current collector 12, allowing the methanol aqueous solution in the tank chamber 14a to be supplied to the anode 11B though the flow openings 12a.

[Carbon Dioxide Separating Membrane]

The carbon dioxide separating member 15 is a gas separating membrane that separates carbon dioxide that has been produced at the anode 11B due to power generation and then entered the methanol aqueous solution in the fuel tank 14. The carbon dioxide separating member 15 according to the first embodiment is a so-called plate membrane; an exemplary usable plate membrane is a porous membrane that uses polytetrafluoroethylene as a basic material. The carbon dioxide separating member 15 is overlaid by the fuel tank 14, which is frame-shaped, in such a way that the carbon dioxide separating member 15 covers the opening of the fuel tank 14 diametrically opposite to the MEA 11 (the lower opening in FIG. 4).

The carbon dioxide produced due to power generation and mixed with the methanol aqueous solution in the fuel tank 14 is separated when the carbon dioxide passes through the carbon dioxide separating member 15. The carbon dioxide then passes through an opening 23a, described below, in the case 21 and is ejected to the outside. Accordingly, the carbon dioxide does not remain in the fuel tank 14 for a long period of time, enabling methanol aqueous solution to be preferably supplied from the fuel cartridge 41 to the tank chamber 14a, so insufficiency of methanol aqueous solution to be supplied to the anode 11B (so-called fuel insufficiency) does not occur easily. As a result, the MEA 11 continues to superiorly generate power.

[Interposing Plates]

The interposing plate 16 and interposing plate 17 are disposed at both outer sides of the DMFC body 10; the interposing plate 16 is disposed outside the current collector 13 (on the upper side in FIG. 4), and the interposing plate 17 is disposed outside the carbon dioxide separating member 15 (on the lower side in FIG. 4). Edge 22b and edge 23b, described below, of the case 21 interpose the interposing plate 16 and interposing plate 17, holding the DMFC body 10 in the thickness direction.

The overlapping state of the MEA 11, current collector 12, current collector 13, fuel tank 14, and carbon dioxide separating member 15 is held. This, for example, assures more tight contact between the current collector 12 and anode 11B and between the current collector 13 and cathode 11C. Power can then be retrieved with less loss, according to the potential difference generated at the MEA 11.

The interposing plate 16 has a plurality of flow openings 16a, in correspondence to the plurality of flow openings 13a in the current collector 13. Passing though the flow openings 13a and flow openings 16a, air including oxygen flows from the outside to the cathode 11C and water vapor (water) generated at the cathode 11C due to power generation flows to the outside. As with the interposing plate 16, the interposing plate 17 has a plurality of flow openings 17a. Carbon dioxide that has been separated by carbon dioxide separating member 15 and methanol aqueous solution (methanol and water) that has permeated into and passed through the carbon dioxide separating member 15 pass through the flow openings 17a and are ejected to the outside.

<Case>

The case 21 is a thick plate-like body; it comprises an upper half 22 and lower half 23, which are combined by an appropriate means such as bolts. The case 21 encloses and holds the DMFC body 10; it is a container that protects the DMFC body 10. The case 21 has an internal space 21a in which the control board 51 (electronic parts) and capacitor 52 are accommodated.

[Upper Half]

The upper half 22 has an opening 22a through which a part of the interposing plate 16 corresponding to the cathode 11C in the MEA 11 is opened to the outside. The upper half 22 also has edges 22b that define the opening 22a. Passing through the opening 22a, air flows from the outside to the cathode 11C and water vapor (water) flows from the cathode 11C to the outside. A mesh lid 22c is fixed to the upper half 22, which covers the opening 22a, protecting the DMFC body 10.

The edges 22b of the upper half 22 and edges 23b, described below, of the lower half 23 interpose the DMFC body 10 in the thickness direction.

The upper half 22 has a plurality of grooves 22d (four grooves in FIG. 3) that communicate with the opening 22a from two sides (on the front right side and back left side in FIG. 3) of the case 21. Therefore, when the DMFC unit U1, for example, is inserted into the slot 101a (accommodating part, see FIG. 1) that accommodates the DMFC unit of the notebook computer, even if the upper surface of the upper half 22 is brought close to one of the wall surfaces that define the slot 110a, the water or water vapor flows from the opening 22a to the outside at the two sides of the case 21 through the grooves 22d.

The groove 22d is formed so that its bottom 22e is brought close to the MEA 11, that is, the distance d1 (see FIG. 4) between the bottom 22e and interposing plate 16 is set so that it is minimized. Accordingly, the water vapor generated at cathode 11C flows easily from the opening 22a into the grooves 22d. As a result, the water vapor can be superiorly ejected to the outside.

The grooves 22d are formed so that they are positioned above the flow path F1 (see FIG. 2) that communicates with the outlet ports 101c of the notebook computer 100 as described above. When the air that flows through the flow path passes though the grooves 22d, supply of air to the cathode 11C and ejection of water vapor from the cathode 11C are superiorly performed together.

As viewed from the top of the upper half 22, the positions of the grooves 22d correspond to the positions of the flow openings 13a and flow openings 16a. This allows preferable flow of air and water vapor between the grooves 22d and flow openings 13a and between the grooves 22d and flow openings 16a.

[Lower Half]

The lower half 23 has an opening 23a that partially opens the carbon dioxide separating member 15 to the outside. Carbon dioxide that has been separated by carbon dioxide separating member 15 and methanol aqueous solution etc. that have permeated into and passed through the carbon dioxide separating member 15 pass through the flow openings 23a. A mesh lid 23c is fixed to the lower half 23, which covers the opening 23a. The lower half 23 has edges 23b that define the opening 23a.

The lower half 23 has a plurality of grooves 23d (four grooves in FIG. 5) that communicate with the opening 23a from two sides (on the front right side and back left side in FIG. 5) of the case 21 (see FIG. 5). Therefore, even if the lower surface of the lower half 23 is brought close to one of the wall surfaces that define the slot 110a, carbon dioxide flows from the opening 23a to the outside at the two sides of the case 21 through the grooves 23d.

The groove 23d is formed so that its bottom 23e is brought close to the MEA 11, so the carbon dioxide etc, can flow from the opening 23a into the groove 23d easily. The grooves 23d are formed so that they are positioned above the flow path that communicates with the outlet ports 101c of the notebook computer 100. When the fan 103a rotates and air flows through the grooves 23d, the carbon dioxide, etc. are preferably ejected together.

<Seal Members>

The seal member 31 and seal member 32 are ring-shaped. The seal member 31 is disposed between the edges 22b of the upper half 22 and the interposing plate 16 of the DMFC body 10. The seal member 32 is disposed between the interposing plate 17 and the edges 23b that define the opening 23a of the lower half 23. The seal member 31 and seal member 32 are made of an elastically deformable material such as polytetrafluoroethylene or styrene-butadiene rubber (SBR). The seal member 31 provides a sealing effect by being interposed between the edges 22b and interposing plate 16 and elastically deformed; it shields the opening 22a from the internal space 21a. The seal member 32 provides a sealing effect by being interposed between the edges 23b and interposing plate 17 and elastically deformed; it shields the opening 23a from the internal space 21a.

The seal member 31 has an adhesive layer that adheres to the upper half 22 and interposing plate 16, which touch the surfaces of the seal member 31, so the seal member 31 adheres to these members, increasing the effect of the sealing; the seal member 32 has another adhesive layer that adheres to the lower half 23 and interposing plate 17, which touch the surfaces of the seal member 32, so the seal member 32 adheres to these members, increasing the effect of the sealing.

As described above, since the seal member 31 shields the opening 22a from the internal space 21a, it prevents the water vapor generated at the cathode 11C from entering the internal space 21a; since the seal member 32 shields the opening 23a from the internal space 21a, it prevents the methanol aqueous solution, its vapor, etc. that have permeated into and passed through the carbon dioxide separating member 15 from entering the internal space 21a.

Prevention of entrance of water vapor etc. into the internal space 21a enables the control board 51 (electronic parts) and capacitor 52 to be accommodated into the internal spacing 21a without having to consider the effect of water vapor etc. Specifically, even when the control board 51 and other components are accommodated in the internal space 21a and the case 21 includes the DMFC body 10, control board 51, and other components as a package, the control board 51 and other components are not deteriorated by water vapor etc. This increases the reliability and durability of the DMFC unit U1.

<Fuel Cartridge>

The fuel cartridge 41 is detachably fixed to the front right of the case 21 as shown in FIG. 3. The fuel cartridge 41 includes methanol aqueous solution, the methanol (fuel component) concentration of which is, for example, 10% by mass as well as a propellant gas. The fuel cartridge 41 is connected to the fuel pipe 14b of the fuel tank 14 through another pipe (not shown); the methanol aqueous solution is extruded by the propellant gas and supplied to the fuel tank 14.

<Control Board>

The control board 51 is disposed in the internal space 21a of the case 21 by means of bosses or the like. The control board 51 is connected to an output terminal of the MEA 11; it is an electronic part that receives power from the MEA 11 and operates to, for example, increase or decrease the output voltage of the DMFC body 10. The use of the control board 51 enables, for example, control of output from the DMFC unit U1 according to the rated output of the notebook computer (electronic apparatus).

<Capacitor>

The capacitor 52 is disposed in the internal space 21a of the case 21 by means of bosses or the like. The capacitor 52 is connected to an output terminal of the MEA 11, enabling power from the MEA 11 to be stored. Accordingly, a prescribed amount of power can be stored in the capacitor 52 in advance; when the output from the MEA 11 is unstable at the initial stage of power generation, for example, the notebook computer is given a priority to receive power from the capacitor 52. Alternatively, excessive power can be stored in the capacitor 52. The capacitor 52 includes at least either of an electric dual-layer capacitor and secondary cell.

<<Operation of the DMFC Unit>>

Next, the operation of the DMFC unit U1 will be described mainly with reference to FIG. 4.

<On the Anode Side of the DMFC Unit>

First, the operation on the anode 11B side of the DMFC unit U1 will be described. Methanol aqueous solution (the methanol concentration is 10% by mass, for example) is supplied form the fuel cartridge 41 to the tank chamber 14a. The methanol aqueous solution in the tank chamber 14a is then supplied to the entire surface of the anode 11B through the flow openings 12a in the current collector 12.

At the anode 11B supplied with the methanol aqueous solution, methanol reacts with water to yield protons (H⁺), carbon dioxide (CO₂), and electrons (e⁻) in the presence of supported platinum or another catalyst according to a power request from the notebook computer 100, as indicated by formula (1). The protons (H⁺) then use the concentration gradient as driving force to move toward the cathode 11C in the electrolyte membrane 11A.
CH₃OH+H₂O→CO₂+6H⁺+6e⁻ (1)

As indicated by formula (1), the carbon dioxide generated at the anode 11B passes through the flow openings 12a from the anode 11B and enters the methanol aqueous solution in the tank chamber 14a. The carbon dioxide permeates into and passes through the carbon dioxide separating member 15, passes through the flow openings 17a, and is ejected to the opening 23a. The methanol aqueous solution in the tank chamber 14a slightly permeates into and passes through the carbon dioxide separating member 15. Since the clearance between the edges 23b and the interposing plate 17 of the DMFC body 10 is sealed by the seal member 32, however, the carbon dioxide and methanol aqueous solution that have passed do not enter the internal space 21a.

<On the Cathode Side of the DMFC Unit>

Next, the operation on the cathode 11C side of the DMFC unit U1 will be described. External air including oxygen passes through the flow openings 16a and flow openings 13a from the opening 22a and is supplied to the cathode 11C. At the cathode 11C, the oxygen, the protons (H⁺) that have passed through the electrolyte membrane 11A, and the electrons (e⁻) that have passed through the notebook computer 100 (external load) react with one another to generate water vapor, as indicated by formula (2).
O₂+4H⁺+4e⁻→2H₂O (2)

The generated water vapor passes through the flow openings 13a and flow openings 16a and is ejected to the opening 22a. Since the clearance between the edges 22b and interposing plate 16 is sealed by the seal member 31, the water vapor does not enter the internal spacing 21a.

As described above, the DMFC unit U1 does not allow the water vapor generated at the cathode 11C and the methanol aqueous solution passing through the carbon dioxide separating member 15 to enter the internal space 21a, so the control board 51 and capacitor 52 are protected, increasing the durability of the DMFC unit U1.

The DMFC body 10 generates heat due to power generation. The heat is transferred to the case 21 through the seal member 31 and seal member 32, and then dissipated to the air that flows through the grooves 22d and grooves 23d.

### 2. Second Embodiment

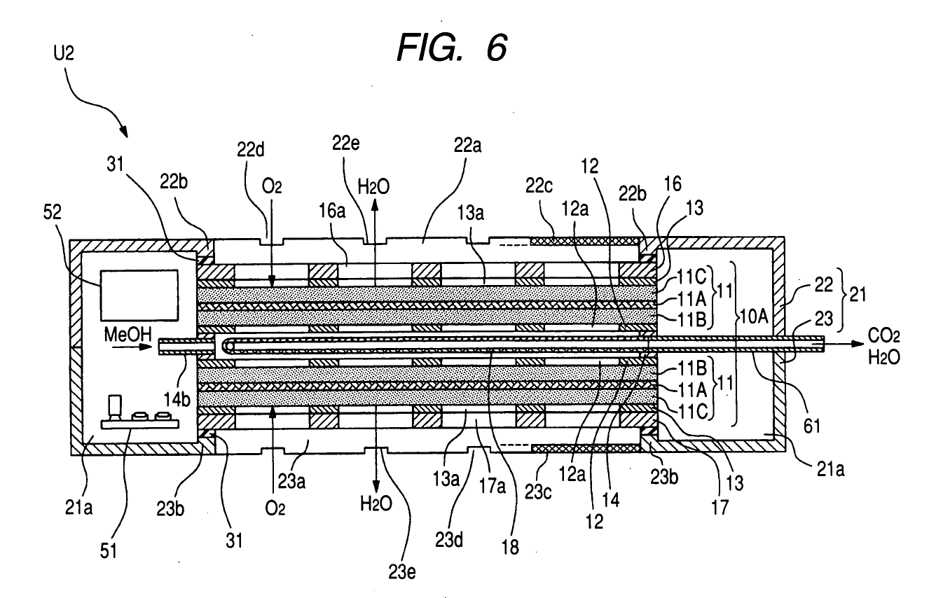

Next, a DMFC unit according to the second embodiment will be described with reference to FIG. 6. FIG. 6 is a cross-sectional view of the DMFC unit according to the second embodiment.

<<Structure of the DMFC Unit>>

As shown in FIG. 6, the DMFC unit U2 according to the second embodiment has a DMFC body 10A and carbon oxide discharge tube 61 (gas ejection tube) instead of the DMFC body 10 according to the first embodiment.

<DMFC Body>

The DMFC body 10A has two MEAs 11. The anode 11B of one MEA 11 faces the anode 11B of the other MEA 11, and the two MEAs 11 interpose the fuel tank 14; that is, the two MEAs 11 are symmetrically disposed around the fuel tank 14.

<Carbon Dioxide Separating Membrane Tube>

The DMFC body 10A further has a carbon dioxide separating member tube 18 (gas separating membrane tube) that selectively allows carbon dioxide to pass so that it is separated. The carbon dioxide separating member tube 18 is laid in a serpentine manner in the tank chamber 14a of the fuel tank 14; one end (on the right side in FIG. 6) of the carbon dioxide separating member tube 18 extends externally from the fuel tank 14. The carbon dioxide, which has been produced due to power generation at the anodes 11B oppositely disposed and then entered the methanol aqueous solution in the tank chamber 14a, is separated by passing though the peripheral wall of the carbon dioxide separating member tube 18, and then ejected to the outside of the fuel tank 14.

The methanol aqueous solution (methanol and water) slightly permeates into and passes through the carbon dioxide separating member tube 18 as in the case of the carbon dioxide separating member 15 according to the first embodiment, and is ejected to the outside of the fuel tank 14.

<Carbon Dioxide Ejection Tube>

A carbon dioxide ejection tube 61 leads carbon dioxide separating member tube 18 to the outside of the case 21. Accordingly, the ejected carbon dioxide and methanol aqueous solution pass through the carbon dioxide discharge tube 61 and are further ejected to the outside of the case 21. This prevents the carbon dioxide and methanol aqueous solution from entering the internal space 21a of the case 21, preferably protecting the control board 51.

### 3. Third Embodiment

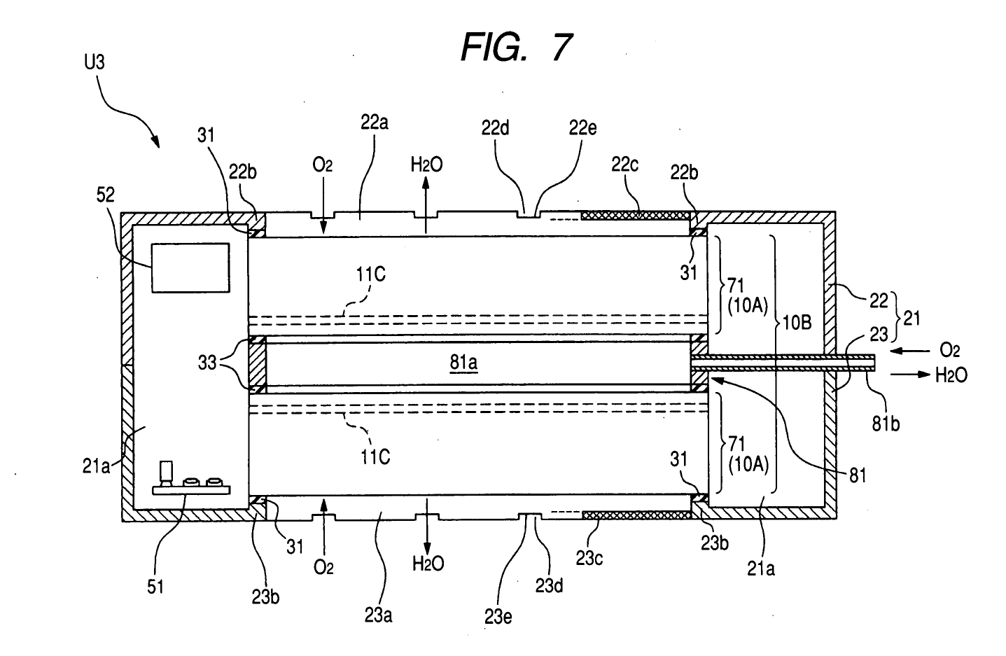

Next, a DMFC unit according to the third embodiment will be described with reference to FIG. 7. FIG. 7 is a cross-sectional view of the DMFC unit according to the third embodiment.

<<Structure of the DMFC Unit>>

As shown in FIG. 7, the DMFC unit U3 according to the third embodiment has a DMFC body 10B. The DMFC body 10B has two DMFC packs 71, a cathode flow path member 81, which is frame-shaped, and two seal members 33, which are ring-shaped. The DMFC body 10B is a lamination of one DMFC pack 71, one seal member 33, the cathode flow path member 81, the other seal member 33, and the other DMFC pack 71, which are superposed in that order. The DMFC body 10B structured as described above is interposed between the upper half 22 and lower half 23, which constitute the case 21, from its two sides (the upper side and lower side in FIG. 7).

Accordingly, the seal members 33 are elastically deformed; the upper seal member 33 in FIG. 7 shields the clearance between the upper DMFC pack 71 and cathode flow path member 81, and the lower seal member 33 shields the clearance between the lower DFMC pack 71 and cathode flow path member 81.

The structure of each DMFC pack 71 is the same as the structure of the DMFC body 10A (see FIG. 6) according to the second embodiment. In the DMFC body 10B, therefore, the cathode 11C in the upper DMFC pack 71 and the cathode 11C in the lower DMFC pack 71 are oppositely disposed at both ends of the cathode flow path member 81 although the current collector 13, interposing plate 16, interposing plate 17, etc. (see FIG. 6) are interposed.

<Cathode Flow Path Member>

The cathode flow path 81 is frame-shaped. The hollow interior of the cathode flow path 81 is used as a flow path through which air to be supplied to the cathodes 11C, oppositely disposed, passes and as a flow path through which water vapor (water) generated due to power generation at the cathodes 11C, oppositely disposed, passes.

The cathode flow path 81 is provided with a communicating tube 81b (gas ejection tube) that leads a cathode flow path 81a to the outside of the case 21 as appropriate. Passing through the communicating tube 81b, air including oxygen required for power generation is supplied from the outside of the case 21 into the cathode flow path 81a, and the water vapor generated due to power generation is ejected from the cathode flow path 81a to the outside of the case 21. Accordingly, the MEA 11 including the cathodes 11C, oppositely disposed, does not run out of oxygen, preferably generating power.

As described above, the seal members 33 provide a seal between the cathode flow path member 81 and one of the DMFC packs 71 that interpose the cathode flow path member 81, and provide another seal between the cathode flow path member 81 and the other DMFC pack 71. This prevents water vapor generated at the cathodes 11C, oppositely disposed, from entering the internal space 21a from the cathode flow path 81a, protecting the control board 51 accommodated in the internal space 21a.

The present invention has been described through the preferred embodiments above, but it is to be understood that the present invention is not limited to the embodiments and can be modified, for example, as described below, without departing from the purpose of the present invention.

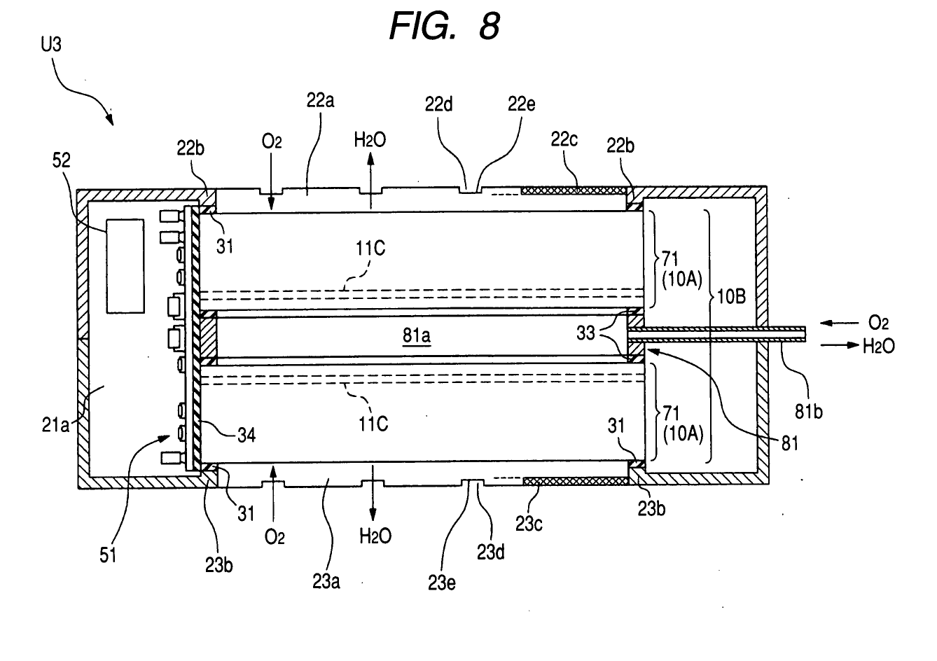

In the third embodiment, the control board 51 is simply accommodated in the internal space 21a. However, as shown in FIG. 8, the control board 51 may be provided a seal member 34 on one side and sealed to the left side surface of the DMFC body 10B.

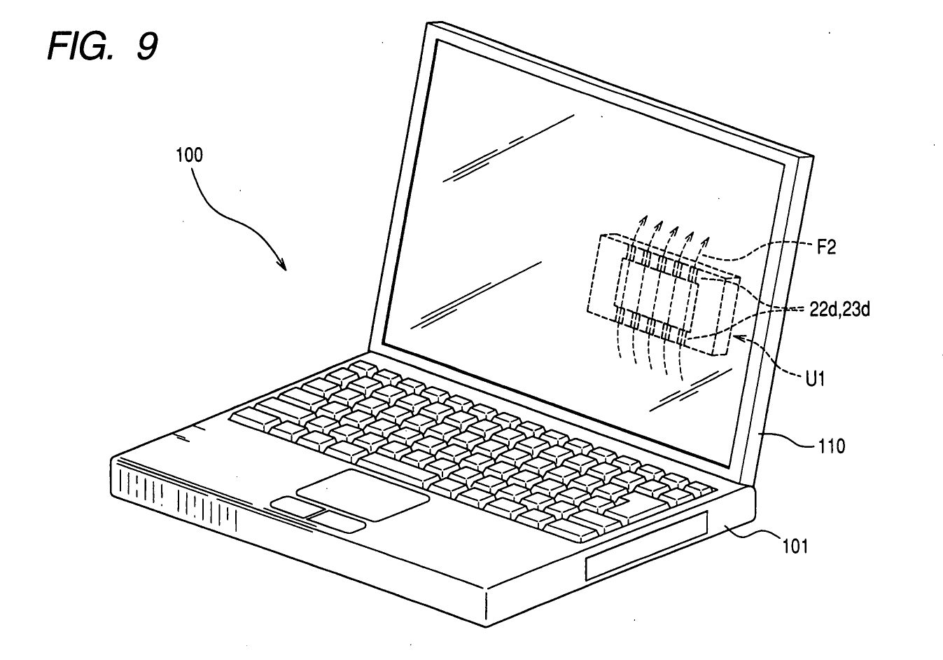

In the first embodiment, the grooves 22d and 23d are disposed above the air flow path that communicates with the outlet parts 101c of the notebook computer 100 (see FIG. 2). For example, however, as shown in FIG. 9, the DMFC unit U1 may be mounted on the back of the liquid crystal display 110 of the notebook computer 100 and positioned so that the grooves 22d and 23d run along an air flow F2 caused by heat generated during power generation by the DFMC unit U1.

In the first embodiment, the electronic apparatus in which the DMFC unit U1 is mounted is the notebook computer 100. However, types of electronic apparatus are not limited to it; a mobile telephone or personal data assistance (PDA) may be used.

4. Fourth Embodiment

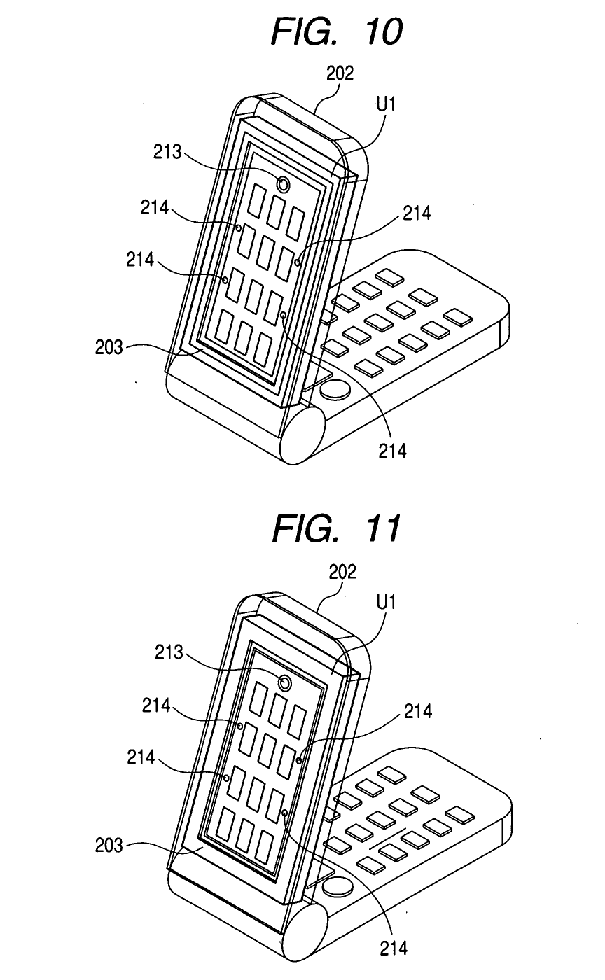

The fourth embodiment of the present invention will be explained by reference to FIGS. 10 to 13 in the following.

The present embodiment relates to a DMF unit (fuel cell unit U1) having a structure of one layer wherein one air electrode is disposed on one side, while in the above embodiments, more than one unit is used. The figures show the state that the DMF unit is built in a portable phone. The fuel cell unit can be used by itself as a main battery for supplying the whole power source or as an auxiliary battery for supplying electric power to a lithium battery or an electric double layer capacitor.

In the present embodiment, the unit is featured in that there is a seal member 203 for gas tightly sealing the fuel supply port 213 and carbon dioxide discharge port 214 from the anode (fuel electrode), as well as the cathode side (air electrode).

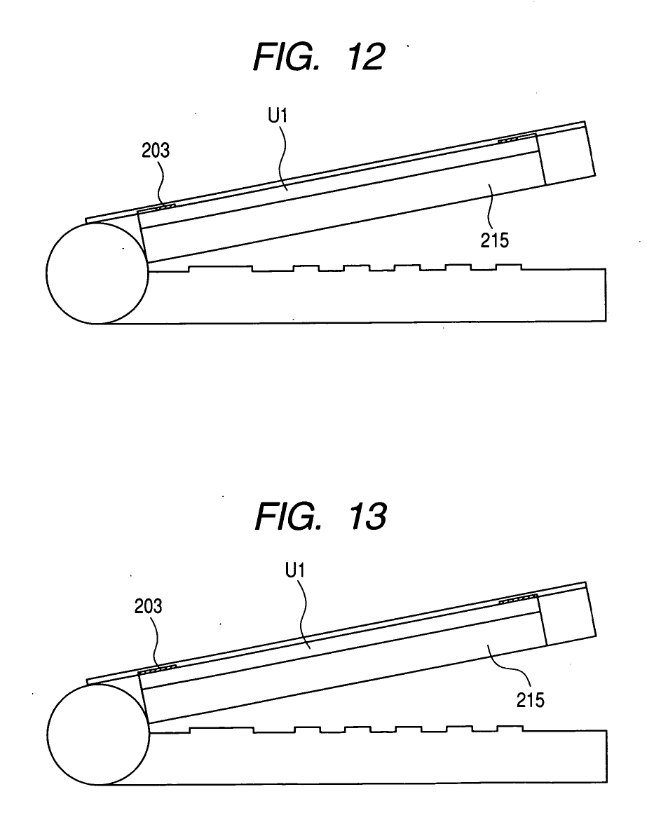

As a material used for the seal member 203, the material mentioned in the previous embodiments are used. As shown in FIG. 12, the material for the seal member 203 should preferably have a good thermal conductivity so that heat generated by the DMF unit (fuel cell unit) during operation does not give adverse affect on a substrate of the portable phone 215, which is located behind the DMF unit U1, is dissipated by the case 202.

Since the conventional portable phones have a problem due to heat, the above structure can achieve liquid sealing and good heat dissipation, which are both important problems in DMFC unit mounted on the portable phone. As the seal member 203, materials with a small thermal resistance such as a thermal conductive sheet used in IC technologies and a thermal conductive grease can be used.

As shown in FIGS. 11 and 13, an area of the seal member 203 can be extended as much as possible by using the thermal conductive sheet so that the heat conduction from the DMF unit U1 to the case 202 is increased.

Although in the drawings of this embodiment, in which the fuel cell module 10 is installed on the rear side of the liquid display 110, the DMF unit U1 can be installed on the rear side of the keyboard.

What is claimed is:

1. A fuel cell unit, comprising:
a fuel cell body having a membrane electrode assembly for generating power, which comprises an anode being supplied with fluid fuel, a cathode being exposed to atmosphere to be supplied with an oxydant, a membrane sandwiched between the anode and cathode, and a fuel tank connected to a fuel cartridge, from which the liquid fuel is supplied to the anode;
a case having an internal space for accommodating an electronic part, the case enclosing and holding the fuel cell body and having an opening in the area of the cathode of the membrane electrode assembly and opened to the outside; and
a seal member for providing a seal between the edges surrounding the opening in the case and the fuel cell body to shield the internal space from the opening.

2. A fuel cell unit, comprising:
a fuel cell body having a membrane electrode assembly that generates power by having fluid fuel supplied to an anode thereof and oxygen to a cathode thereof and yields water at the cathode due to the power generation, and a fuel tank connected to a fuel cartridge, from which liquid fuel is supplied to the anode;
a case having an internal space for accommodating an electronic part, the case enclosing and holding the fuel cell body and having an opening formed by the cathode of the membrane electrode assembly and opened to the outside; and
a seal member for providing a seal between the edges surrounding the opening in the case and the fuel cell body to shield the internal space from the opening.

3. A fuel cell unit according to claim 1, wherein an opening is formed in the gas separating membrane side located at the anode side.

4. The fuel cell unit according to claim 1, wherein the case has a groove for leading the opening to the outside.

5. The fuel cell unit according to claim 4, wherein the groove is formed with the bottom being brought close to the membrane electrode assembly.

6. The fuel cell unit according to claim 4, wherein: the fuel cell unit is mounted in an electronic apparatus that has an outlet port; and the groove is set so that it is disposed on an air flow path that communicates with the outlet port.

7. The fuel cell unit according to claim 6, wherein the groove is set so that it runs along an air flow caused by heat generated during power generation.

8. A fuel cell unit, comprising:
a fuel cell body having at least two membrane electrode assemblies each of which generates power by having fluid fuel supplied to an anode thereof and oxygen to a cathode thereof and yields water at the cathode due to the power generation, and a cathode flow path member having a cathode flow path through which oxygen to be supplied to the cathode and water generated at the cathode pass, the cathodes in the at least two membrane assemblies facing each other and interposing the cathode flow path member; and
a case having an internal space for accommodating an electronic part, the case enclosing and holding the fuel cell body;
wherein seal members are further included to provide a seal between each of the cathodes facing each other and the cathode flow path member to shield the internal space from the cathode flow path member.

9. The fuel cell unit according to claim 8, wherein the seal member is made of an elastically deformable material and provides a seal by being elastically deformed.

10. The fuel cell unit according to claim 9, wherein the seal member has an adhesive layer that adheres to a member that touches the surface of the adhesive layer.

11. A fuel cell unit, comprising:
a fuel cell body having a membrane electrode assembly that generates power by having fluid fuel supplied to an anode thereof and oxygen to a cathode thereof and yields water at the cathode due to the power generation, a fuel tank from which fluid fuel is supplied to the anode, and a gas separating membrane tube for internally separating gas that is yielded at the anode and enters the liquid fuel in the fuel tank and ejecting the gas to the outside of the fuel tank;
a case having an internal space for accommodating an electronic part, the case enclosing and holding the fuel cell body; and
a gas discharge tube for leading the gas separating membrane tube to the outside of the case;
wherein the gas yielded at the anode passes through the gas separating membrane tube and the gas discharge tube and is ejected to the outside.

12. The fuel cell unit according to claim 11, further comprising an electronic part that operates when it receives power from the membrane electrode assembly, the electronic part being disposed in the internal space.

13. The fuel cell unit according to claim 12, further comprising a capacitor that is capable of storing power from the membrane electrode assembly, the capacitor being disposed in the internal space.

14. The fuel cell unit according to claim 13, wherein the capacitor includes at least either of an electric dual-layer capacitor and a secondary cell.

15. The fuel cell unit according to claim 1, wherein the seal member has a high thermal conductivity, thereby transmitting heat from the fuel cell to the case.

16. The fuel cell unit according to claim 8, wherein the seal member has a high thermal conductivity, thereby transmitting heat from the fuel cell to the case.

17. The fuel cell unit according to claim 11, wherein the seal member has a high thermal conductivity, thereby transmitting heat from the fuel cell to the case.

18. The fuel cell unit according to claim 1, wherein the seal member has a structure thereby to suppress a transfer of at least gas between a fuel supply port of the fuel cell for supplying necessary fuel for electric generation by the fuel cell and the case.

19. The fuel cell unit according to claim 8, wherein the seal member has a structure thereby to suppress a transfer of at least gas between a fuel supply port of the fuel cell for supplying necessary fuel for electric generation by the fuel cell and the case.

20. The fuel cell unit according to claim 8, wherein the seal member has a structure thereby to suppress a transfer of at least gas between a fuel supply port of the fuel cell for supplying necessary fuel for electric generation by the fuel cell and the case.

21. An electronic apparatus in which the fuel cell unit according to claim 11 is mounted.

22. An electronic apparatus in which the fuel cell unit according to claim 2 is mounted.

23. An electronic apparatus in which the fuel cell unit according to claim 8 is mounted.

24. An electronic apparatus in which the fuel cell unit according to claim 11 is mounted.
